(19) United States
(12) Patent Application Publication
(10) Pub. No.: US 2026/0103067 A1
(43) Pub. Date: Apr. 16, 2026

(54) ADJUSTABLE VISIBLE VANES FOR AN ADJUSTABLE GRILLE SHUTTER SYSTEM

(71) Applicant: Magna Exteriors Inc., Aurora (CA)

(72) Inventor: Jeffrey Caraway, Oxford, MI (US)

(73) Assignee: Magna Exteriors Inc., Aurora, ON (CA)

(21) Appl. No.: 19/116,714

(22) PCT Filed: Sep. 29, 2023
(86) PCT No.: PCT/US2023/075549

§ 371 Date: Mar. 28, 2025

Related U.S. Application Data
(60) Provisional application No. 63/411,409, filed on Sep. 29, 2022.

(51) Int. Cl. B60K 11/08

(52) U.S. Cl. CPC B60K 11/085

(57) ABSTRACT

An active shutter vane assembly has a mini-vane base member which includes an actuation attachment portion and a vane attachment portion. A beauty vane, which includes a cooperating attachment structure for attachment of the beauty vane to the mini-vane, is attached to the mini-vane. This allows the beauty vane to be interchangeable and preselected for a particular vehicle during assembly. The mini-vane and beauty vane assembly attach to an active shutter assembly which is used on several different vehicle platforms and the beauty vanes may be customized to each platform.

### CROSS-REFERENCE TO RELATED APPLICATIONS

This application is a PCT International Patent Application and claims benefit of United States Provisional Ser. No. 63/411,409, filed Sep. 29, 2022. The disclosure of the above application is incorporated herein by reference.

### FIELD OF THE INVENTION

The present invention relates to adjustable visible vanes for an adjustable grille shutter system.

### BACKGROUND OF THE INVENTION

Adjustable grille shutters have become desirable in vehicle grille applications to better control and regulate engine temperatures and provide better aerodynamics to vehicles. In a typical application a rack of vanes is placed in front of a vehicle radiator which has several vanes which are connected by a linkage to open and close as needed or desired during operation of the vehicle. These movable vane assemblies must be either designed specifically to match the aesthetics of a particular vehicle or a generic unit must be used behind an aesthetically designed grille fascia.

For visible active grille systems, new tooling is required for every styling package of the vehicle. Additionally, the fascia opening is slightly different shape between the packages. It is desirable to provide an aesthetically stylized grille system that will be customizable and useful in various vehicles while maintaining an underlying vane articulation structure.

### SUMMARY OF THE INVENTION

An active shutter vane assembly comprising:
A mini-vane base member which includes an actuation attachment portion and a vane attachment portion; and
A beauty vane which includes a cooperating attachment structure for attachment of the beauty vane to the mini-vane.

The mini-vanes can be used for all the vanes on the car. They can also be used on different styling packages. The beauty vane is slid on or otherwise attached to the face of the mini-vanes. Each beauty vane is made to match up to the environment, styling and linkage to the mini-vane and its actuation drive as needed.
1. The mini-vane connects to the linkage as a rotator for opening and closing the vanes as required or desired when operating the vehicle.
2. The beauty vane slides onto the mini-vane. It also connects to the linkage which sets the kinematics.

Use of a smaller support structure (mini-vane) in allowing the vanes of the system to be modular which provides for interchangeability and cross vehicle platform compatibility.

This allows the beauty vane to be interchangeable and preselected for a particular vehicle during assembly. The mini-vane and beauty vane assembly attach to an active shutter assembly which is used on several different vehicle platforms and the beauty vanes may be customized to each platform. This in the present invention a mini- vane structure is used for support and is designed for receiving an aesthetic beauty vane. The beauty vane will be made to match the styling package. To make the vanes modular to a changing environment.

Further there is provided a process for assembling an active shutter vane assembly comprising the steps of:
A. Providing a mini-vane base member which includes an actuation attachment portion and a vane attachment portion said vane attachment portion including a pair of lip portions extending outward each including an inwardly extending tab opening;
B. Providing a first beauty vane having a first show surface contour compatible with a first vehicle appearance which includes a cooperating attachment structure for attachment of the beauty vane to the mini-vane, wherein the cooperating attachment structure on the beauty vane has at least a pair of tabs on opposite sides for forming a channel underneath the tabs which is inserted through said tab openings and slid longitudinally along the lip for connection of the first beauty vane to the mini-vane base member;
C. Providing a second beauty vane having a second show surface contour compatible with a second vehicle appearance which includes a cooperating attachment structure for attachment of the beauty vane to the mini-vane, wherein the cooperating attachment structure on the beauty vane has at least a pair of tabs on opposite sides for forming a channel underneath the tabs which is inserted through said tab openings and slid longitudinally along the lip for connection of the second beauty vane to the mini-vane base member;
D. Selecting one of said first beauty vane or said second beauty vane depending on which preselected first vehicle or second vehicle the base member is to be installed in and installing the selected first beauty vane onto the mini-vane base member; and
E. Installing the active shutter vane assembly on the preselected vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view partially broken away showing an active shutter vane assembly in accordance with the present invention;

FIG. 2 is a sectional view of a vane assembly of the active shutter vane assembly of the present invention;

FIG. 3 is a lateral sectional view taken along line 3-3 of FIG. 2 showing the contour along the width of the vane assembly of the active shutter vane assembly in accordance with the present invention;

FIG. 4 is a top view of a first embodiment showing the contour of a beauty vane attached to a mini-vane base of the active shutter vane assembly in accordance with the present invention;

FIG. 4A is a top view of a second embodiment showing the contour of a second beauty vane attached to a mini-vane base of the active shutter vane assembly in accordance with the present invention;

FIG. 5 is a bottom view of the assembly of FIG. 4;

FIG. 5A is a bottom view of the assembly of FIG. 4A;

FIG. 6 is a front view of the assembly of FIG. 4; and,

FIG. 6A is a front view of the assembly of FIG. 4A.

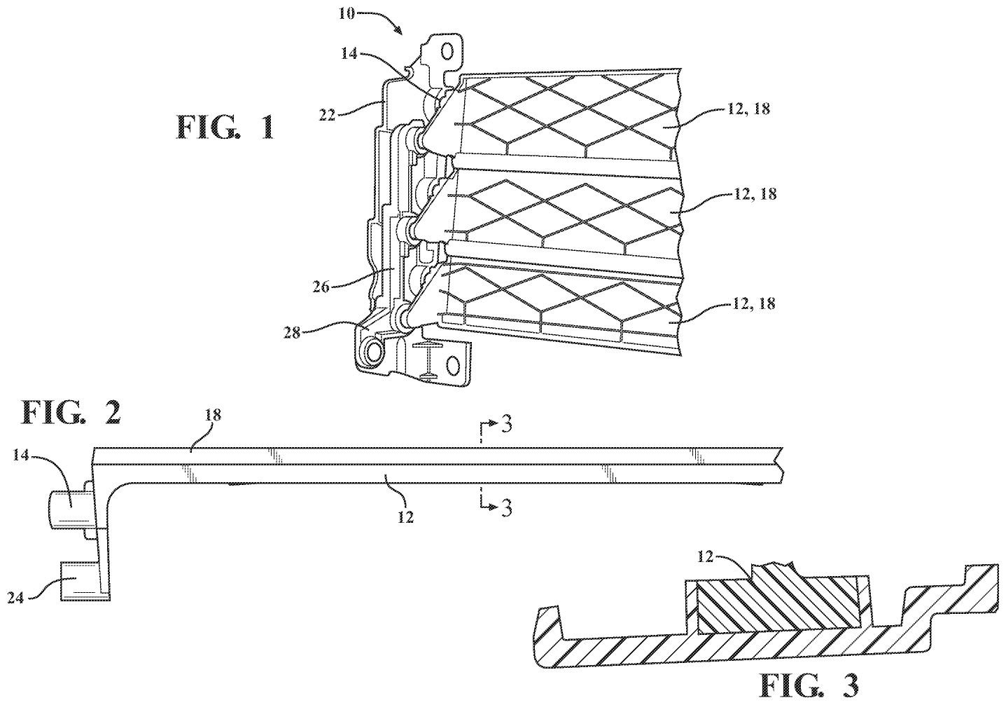

### DETAILED DESCRIPTION OF THE PREFERRED EMBODIMENTS

The following description of the preferred embodiment(s) is merely exemplary in nature and is in no way intended to limit the invention, its application, or uses.

Referring now to the drawings, in accordance with the present invention there is provided an active shutter vane assembly generally shown at 10. Active shutter vane assembly 10 has a mini-vane base member 12 which includes an actuation attachment portion generally indicated at 14 and a vane attachment portion generally indicated at 16. A beauty vane is generally indicated at 18. Beauty vane 18 includes a cooperating attachment structure 20 for attachment of the beauty vane 18 to the mini-vane base member 12. This allows the beauty vane 18 to be interchangeable and preselected for a particular vehicle (not shown) during assembly. After assembly of the mini-vane 12 and beauty vane 18 together they attach to an active shutter assembly frame 22 with other like assemblies (12, 18) which is used on several different vehicle platforms and the beauty vanes 18 may be customized to each platform such that different looks or sizes of grille openings accommodate with a single frame assembly 22. Beauty vane 14 includes a frame actuation engagement portion 24 which nests or snap fits to the mini-vane 12 which cooperates with actuation arm 26 for the drive linkage 28. Mini-vane actuation attachment portion 14 fits into rotation fixtures 30 on the frame 22.

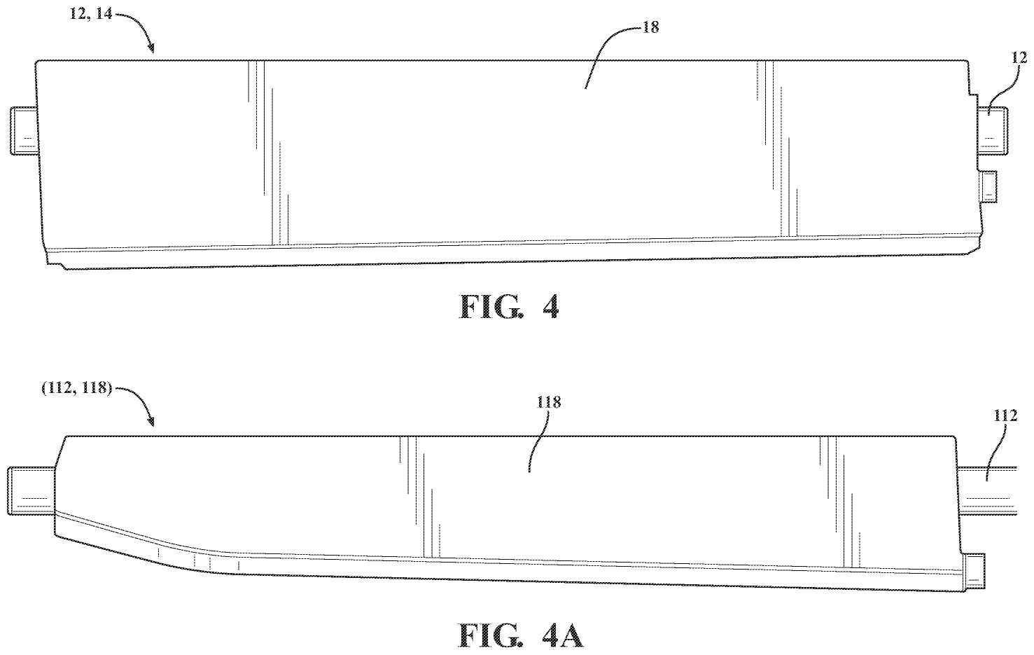

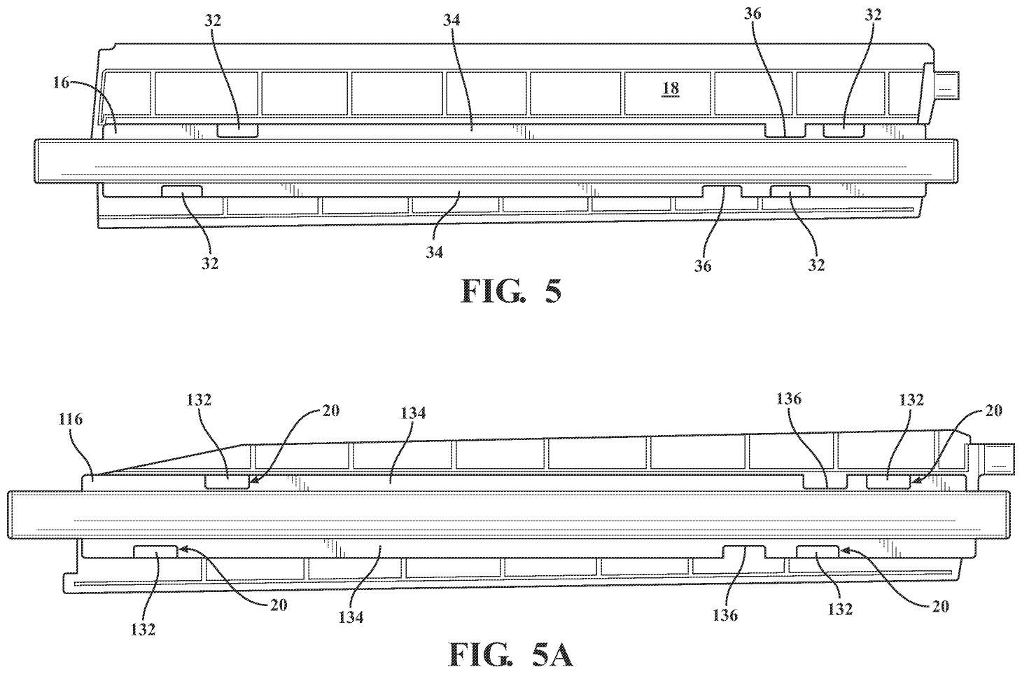

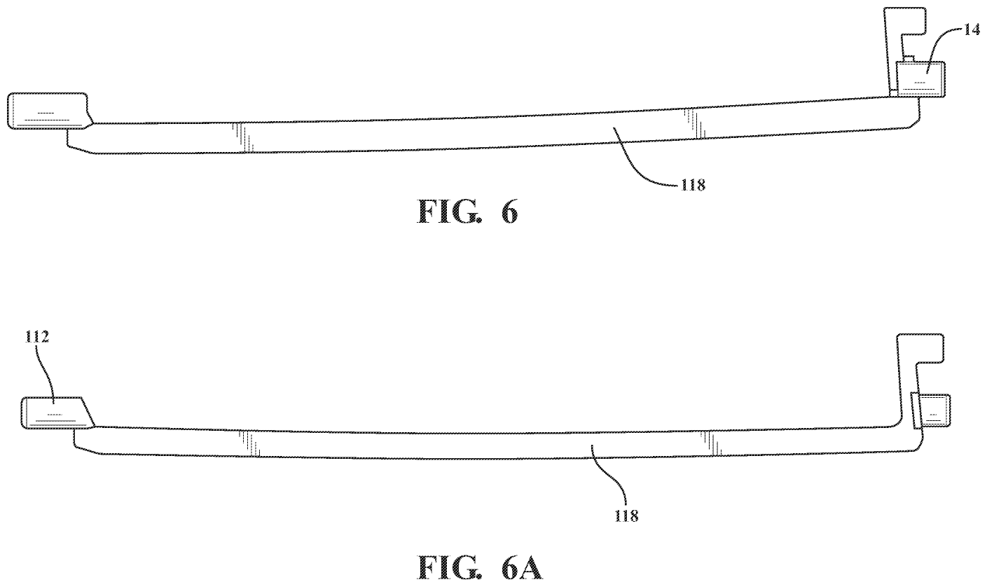

Referring now to FIGS. 4 through 6 and 4A through 6A there is shown a first vehicle program which uses a first configuration of beauty vanes 18 and a second vehicle program uses a second configuration of beauty vanes 118. Either the first configuration of beauty vanes 18 or said second configuration of beauty vanes 118 is selected depending on the vehicle program. Thus, the first configuration of beauty vanes 18 and the second configuration of beauty vanes 118 are interchangeably attached to a mini-vane base member 12 or 112 (which remain the same).

The vane attachment portions 16, 116 of the beauty vanes 18 and 118 and mini-vane base 112, one of the mini-vane attachment portions or cooperating attachment structure on the beauty vane has at least a pair of tabs 32, 132 on opposite sides for forming a channel and the other of said mini-vane attachment portion or the cooperating attachment structure on the beauty vane has a lip 34, 134 which engages in the channel for connection of the beauty vane to the mini-vane base member. Holes 36, 136 are provided in the lips 34, 134 which allow for a lead in past the tab to slide the beauty vane 18 or 118 on.

In operation, the beauty vanes are slid over the base longitudinally and the tabs 36 and 136 are placed through the holes and slid past the holes for engaging the lips 34, 134. The beauty vanes cover the mini-vane and provide a show surface which can be painted to a class A paint match surface of a vehicle. The beauty vanes are preferably made from a flexible TPO material which allows longitudinal flexing of the same shutter vane frame is utilized over many types of vehicle models with only the beauty vanes changing between platforms to change the appearance of the shutter system or in some cases functionality of the system may be changed by incorporating functional features into the beauty vanes. Thus, in accordance with the process aspects of the present invention the process includes a process for assembling an active shutter vane assembly comprising the steps of:
A. Providing a mini-vane base member which includes an actuation attachment portion and a vane attachment portion said vane attachment portion including a pair of lip portions extending outward each including an inwardly extending tab opening;
B. Providing a first beauty vane having a first show surface contour compatible with a first vehicle appearance which includes a cooperating attachment structure for attachment of the beauty vane to the mini-vane, wherein the cooperating attachment structure on the beauty vane has at least a pair of tabs on opposite sides for forming a channel underneath the tabs which is inserted through said tab openings and slid longitudinally along the lip for connection of the first beauty vane to the mini-vane base member;
C. Providing a second beauty vane having a second show surface contour compatible with a second vehicle appearance which includes a cooperating attachment structure for attachment of the beauty vane to the mini-vane, wherein the cooperating attachment structure on the beauty vane has at least a pair of tabs on opposite sides for forming a channel underneath the tabs which is inserted through said tab openings and slid longitudinally along the lip for connection of the second beauty vane to the mini-vane base member;
D. Selecting one of said first beauty vane or said second beauty vane depending on which preselected first vehicle or second vehicle the base member is to be installed in and installing the selected first beauty vane onto the mini-vane base member; and
E. Installing the active shutter vane assembly on the preselected vehicle.

Using the process of the present invention reduces manufacturing costs since the same frame and mini-vane bases can be used in multiple vehicle platforms by selecting particular beauty vanes which correspond to the preselected vehicle platforms.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. An active shutter vane assembly comprising:
a mini-vane base member which includes an actuation attachment portion and a vane attachment portion; and
a beauty vane which includes a cooperating attachment structure for attachment of the beauty vane to the mini-vane.

2. The active shutter vane assembly of claim 1 wherein the beauty vane is attached to both the actuation attachment portion and the vane attachment portion.

3. The active shutter vane assembly of claim 1 wherein the beauty vane includes a class A surface.

4. The active shutter vane assembly of claim 1 wherein the beauty vane visibly covers the mini-vane base member to provide a vehicle show surface.

5. The active shutter vane assembly of claim 1 wherein a first vehicle program uses a first configuration of beauty vanes and a second vehicle program uses a second configuration of beauty vanes and either said first configuration of beauty vanes or said second configuration of beauty vanes is selected depending on the vehicle program selected wherein the first configuration of beauty vanes and the second configuration of beauty vanes are interchangeably attached to a single mini-vane base member.

6. The active shutter vane assembly of claim 1 wherein the beauty vane has a portion which engages a drive linkage on an actuator for driving the vanes and the mini-vane base member has a portion for connecting to a frame for providing a point of rotation to the assembly.

7. The active shutter vane assembly of claim 1 wherein one of the mini-vane attachment portion or cooperating attachment structure on the beauty vane has at least a pair of tabs on opposite sides for forming a channel and the other of said mini-vane attachment portion or the cooperating attachment structure on the beauty vane has a lip which engages in the channel for connection of the beauty vane to the mini-vane base member.

8. The active shutter vane assembly of claim 6 wherein the portion of the beauty vane which engages the drive linkage connects to the mini-vane actuation portion for actuation of the vane assembly.

9. An active shutter vane assembly comprising:
a mini-vane base member which includes an actuation attachment portion and a vane attachment portion; and
a beauty vane which includes a cooperating attachment structure for attachment of the beauty vane to the mini-vane, wherein one of the mini-vane attachment portion or cooperating attachment structure on the beauty vane has at least a pair of tabs on opposite sides for forming a channel and the other of said mini-vane attachment portion or the cooperating attachment structure on the beauty vane has a lip which engages in the channel for connection of the beauty vane to the mini-vane base member, said lip including openings for allowing insertion of the tabs past the lip and sliding the tabs over the lip for engagement of the beauty vane onto said mini-vane base member.

10. The active shutter vane assembly of claim 9 wherein the beauty vane is attached to both the actuation attachment portion and the vane attachment portion.

11. The active shutter vane assembly of claim 9 wherein the beauty vane includes a class A surface.

12. The active shutter vane assembly of claim 9 wherein the beauty vane visibly covers the mini-vane base member to provide a vehicle show surface.

13. The active shutter vane assembly of claim 9 wherein a first vehicle program uses a first configuration of beauty vanes and a second vehicle program uses a second configuration of beauty vanes and either said first configuration of beauty vanes or said second configuration of beauty vanes is selected depending on the vehicle program selected wherein the first configuration of beauty vanes and the second configuration of beauty vanes are interchangeably attached to a single mini-vane base member.

14. The active shutter vane assembly of claim 9 wherein the beauty vane has a portion which engages a drive linkage on an actuator for driving the vanes and the mini-vane base member has a portion for connecting to a frame for providing a point of rotation to the assembly.

15. The active shutter vane assembly of claim 14 wherein the portion of the beauty vane which engages the drive linkage connects to the mini-vane actuation portion for actuation of the vane assembly.

16. An active shutter vane assembly comprising:
a mini-vane base member which includes an actuation attachment portion and a vane attachment portion said vane attachment portion including a pair of lip portions extending outward each including an inwardly extending tab opening; and
a beauty vane which includes a cooperating attachment structure for attachment of the beauty vane to the mini-vane, wherein the cooperating attachment structure on the beauty vane has at least a pair of tabs on opposite sides for forming a channel underneath the tabs which is inserted through said tab openings and slid longitudinally along the lip for connection of the beauty vane to the mini-vane base member.

17. A process for assembling an active shutter vane assembly comprising the steps of:
A. Providing a mini-vane base member which includes an actuation attachment portion and a vane attachment portion said vane attachment portion including a pair of lip portions extending outward each including an inwardly extending tab opening;
B. Providing a first beauty vane having a first show surface contour compatible with a first vehicle appearance which includes a cooperating attachment structure for attachment of the beauty vane to the mini-vane, wherein the cooperating attachment structure on the beauty vane has at least a pair of tabs on opposite sides for forming a channel underneath the tabs which is inserted through said tab openings and slid longitudinally along the lip for connection of the first beauty vane to the mini-vane base member;
C. Providing a second beauty vane having a second show surface contour compatible with a second vehicle appearance which includes a cooperating attachment structure for attachment of the beauty vane to the mini-vane, wherein the cooperating attachment structure on the beauty vane has at least a pair of tabs on opposite sides for forming a channel underneath the tabs which is inserted through said tab openings and slid longitudinally along the lip for connection of the second beauty vane to the mini-vane base member;
D. Selecting one of said first beauty vane or said second beauty vane depending on which preselected first vehicle or second vehicle the base member is to be installed in and installing the selected first beauty vane onto the mini-vane base member; and
E. Installing the active shutter vane assembly on the preselected vehicle.
